(19) United States
(12) Patent Application Publication
(10) Pub. No.: US 2010/0245361 A1
(43) Pub. Date: Sep. 30, 2010

(54) CONTEXT-BASED MANAGEMENT OF MARKERS

(75) Inventors: Eyal Ofek, Redmond, WA (US); Gur Kimchi, Bellevue, WA (US); Avi Bar-Zeev, Redmond, WA (US); Blaise H. Aguera y Arcas, Seattle, WA (US); Stephen L. Lawler, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/415,953

(22) Filed: Mar. 31, 2009

(51) Int. Cl. G06T 11/20; G06Q 30/00

(52) U.S. Cl. 345/441; 705/14.4

(57) ABSTRACT

Aspects relate to determining an appropriate time to render markers to a user. Markers includes any type of information, including messages, photos, advertisements, and so forth. The appropriate time can include internal factors that relate to the user (e.g., mood, preferences, and so on), personal external factors (e.g., scheduled events, location of the user), and/or non-personal external factors (general information about the surroundings, information about local entities). Non-personal external factors can also include the content of the marker. One or more of the contexts are evaluated to ascertain whether a particular marker should be rendered to the user or whether it would be more appropriate not the render the marker (e.g., user would not be receptive to the marker). If the user is not receptive to the marker, rendering of the marker is disabled and/or delayed until a more appropriate time.

### BACKGROUND

Computer-driven route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms “in” on a particular location, details such as names of local roads, identification and location of police and fire stations, identification and location of public services, such as libraries, museums, and the like can be provided. When zooming “out”, the user can glean information from the map such as location of a point of interest within a city, state, and/or country, proximity of the point of interest to major freeways, proximity of the point of interest to a specific city, and the like. In some applications, satellite images can be utilized to provide additional detail regarding a particular geographic location or region. For example, a prospective purchaser of a house can obtain an overhead satellite image of the house, thereby enabling the prospective purchaser to view lines of occupation, proximity of the house to other adjacent houses, power lines, and other pertinent information.

Furthermore, conventional computer-implemented mapping applications often include route-planning applications that can be utilized to provide users with directions between different locations. For example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she wishes to avoid highways, minimize left turns, and so on. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

Although such route planning applications are valuable, such applications do not provide information that supplements the route plan. For example, the application does not consider the value of stops at various locations along the route, deviations from the route, and so forth. Further, such route planning techniques do not provide contextual information that might be helpful to allow the user to make decisions regarding whether the user should perform a particular act (e.g., take a detour into a store, and so forth).

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with providing markers (e.g., data intensive content) based on a context and how receptive the user might be to receiving the marker. The context can be internal factors and/or external factors. Internal factors can relate to orientation of the user (e.g., what the user is looking at), mood of the user, and/or other parameters (e.g., user demographics). External factors can relate to a current time, scheduled appointments, location, commercial enterprise conditions, content of the marker, status of friends and their planned schedule, as well as others. In some aspects, the marker can be an advertisement distributed for the benefit of a commercial enterprise.

According to some aspects, markers can be tailored based on the context and how receptive the user might be to a particular marker. For example, a user's calendar can be accessed and a determination made that the user has an appointment in half an hour. Further, the location of the appointment in relation to the current location of the user can be ascertained. If the appointment location is twenty minutes away and the user is standing in front of a coffee shop, an evaluation can be made whether it is appropriate to present a marker (which can be in the form of an advertisement, for example) to the user. In some cases, it might be determined that outputting the advertisement (or other marker) is inappropriate (e.g., the user is running late for a meeting and does not have time to consume the information). In accordance with other aspects, external information (e.g., is the coffee shop busy, how many people are ahead of this user in line, and so forth) can be evaluated in order to make the determination whether a marker should be presented to the user.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates a system for rendering one or more markers as a function of a context, according to an aspect.

FIG. 2 illustrates an example system for providing markers relevant to an intended destination and/or based on relevant factors in accordance with an aspect.

FIG. 3 illustrates a schematic representation of details related to gathering context information according to various aspects disclosed herein.

FIG. 4 illustrates a schematic representation of details related to selectively choosing one or more markers, according to an aspect.

FIG. 5 illustrates a system for disclosing a marker associated with an intended destination and/or a marker and performing a calculation, according to one or more of the disclosed aspects.

FIG. 6 illustrates a method for selectively rendering markers, according to an aspect.

FIG. 7 illustrated is a block diagram of a computer operable to execute the disclosed architecture

FIG. 8 illustrates a schematic block diagram of an exemplary computing environment in accordance with the various aspects

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Computing systems employing automated learning and reasoning procedures (e.g., the use of explicitly and/or implicitly trained statistical classifiers) can be employed in connection with performing inference and/or probabilistic determinations and/or statistical-based determinations as in accordance with one or more aspects as described hereinafter. As used herein, the term “inference” refers generally to the process of reasoning about or inferring states of the system, environment, and/or user from a set of observations as captured through events, sensors, and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

Various aspects will be presented in terms of systems that may include a number of components, modules, and the like. It is to be understood and appreciated that the various systems may include additional components, modules, and so forth, and/or may not include all of the components, modules, and the like, discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

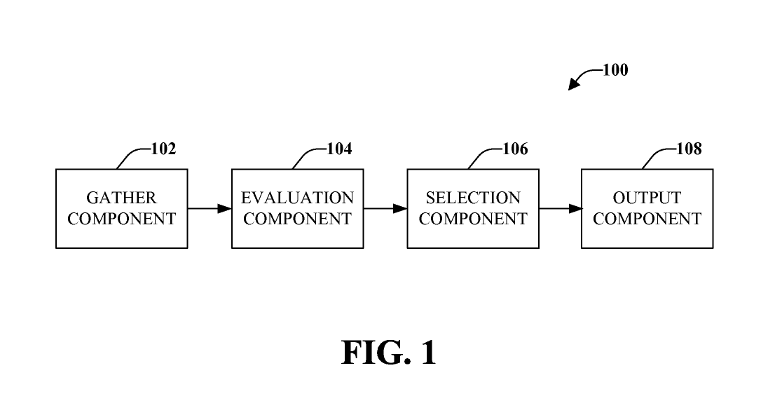

FIG. 1 illustrates a system 100 for rendering one or more markers as a function of a context, according to an aspect. As utilized herein a “marker” can be any information, data, advertisement, photograph, drawing, sensation, fragrance, hyper-link, index to a database, comments, ratings, threaded conversations, news stream, traffic, global events, and/or other content that can be perceived (e.g., visual, audible, tactile, and so forth). Markers can be personalized markers intended specifically for the user (e.g., a message from a friend) and/or generic markers (e.g., an advertisement intended for persons that are near the advertiser's business). In accordance with some aspects, the markers can be classified along a scale, such as from personal to public. Alternatively or additionally, there can be middle cases, such as information that might interest a user based on her profile and/or her friend's profile. System 100 can be included, at least partially, in a user device (e.g., computer, phone, or other computing device), which can be wired and/or wireless. The user device can be carried by the user (e.g., hand, pocket, purse, and so on) or by a vehicle associated with the user (e.g., bicycle, automobile, motorcycle, boat, or through other manners of transportation).

System 100 can be configured to automatically determine when to serve (or render) one or more markers to a user and can also automatically determine when it would be inappropriate to present that marker to the user. System 100 can further be configured to tailor one or more markers based on a context and the receptiveness of the user to the marker(s). According to some aspects, more than one marker can be rendered to a user at substantially the same time or at different times.

Included in system 100 is a gather component 102 that is configured to compile (e.g., gather, request, receive, observe) one or more contexts. The contexts can relate to various external factors associated with the user, sometimes referred to as personal factors. These external factors include a current time, current location, calendar information (e.g., scheduled events, scheduled appointments, planned activities, location (of an event), and so forth), as well as other information associated with the user that can be gathered by gather component 102.

In accordance with some aspects, the contexts can relate to non-personal external factors. These non-personal external factors include general information about the surroundings of a user and/or information about (or sponsored by) entities around the user. As utilized in this context, “entities” refers to people, animals, commercial (as well as non-commercial) establishments, government bodies, and/or other types of commercial and/or social interactions that can occur within the environment or user surroundings. For example, if the user is near a coffee shop, a non-personal external factor can be how many people are in the coffee shop waiting for service, the estimated amount of wait time, specials (e.g., sales or promotions) occurring in the coffee shop, and so on.

In accordance with some aspects, visibility of markers can be determined by the user that entered the marker. For example, if multiple people entered a certain marker, the zoom level used by these users can be utilized as an indication of the level where the marker should be revealed for a new user. According to some aspects, the user that entered the marker can select a zoom level at which the marker should be revealed, even if that level is different than the level at which the marker was entered.

Gather component 102 can gather external information by accessing programs, databases, or other storage mediums located internal to user device and/or accessible by user device (e.g., over a network, over the Internet, and so on). Gather component 102 can automatically access the information and/or request the information from the entity that possesses the information. For example, gather component 102 can automatically access the user's calendar information by establishing a connection with the user's work computer, located in the user's office, and selectively pulling (or prompting the work computer for) the desired information (e.g., what is the user's schedule for the remainder of the day?). In another example, if the information is to be gathered from a commercial establishment, gather component 102 can prompt a server associated with the commercial establishment and request the desired information.

In accordance with some aspects, the external information can be pushed to gather component 102 automatically by the entity that possess the information (e.g. a server associated with a commercial establishment). In this situation, a communication device associated with the entity can periodically, continuously, or based on other parameters (e.g., upon discovery of user device) broadcast information related to markers that the entity would like to be presented by user device (e.g., a promotion, information associated with the entity, and so forth).

According to some aspects, the context can relate to internal factors, such as a user's mood, which can be inferred by the user's tone of voice, manner of speaking, gestures, and/or other identifying information (e.g., facial expression, perspiration, and so forth). Another internal factor can be a user preference, which can be configured by the user and/or inferred by system 100 based on historical user information and/or based on a configuration manually supplied by the user.

In accordance with some aspects, internal factor contexts can relate to orientation of the user (e.g., where the user is looking, the focus of the user, the geographic location of the user). Based on the orientation, one (or more) of alternative markers can be rendered. Thus, if there is more than one marker that can be presented to a user in given context, a determination can be made related to which marker is most appropriate to render, which marker to render first, second, and so forth. For example, if markers in the form of advertisements are to be presented to a user in a given environment (e.g., geographic location), the orientation of the user can be a factor of the direction the user is facing, the side of a street or mall where the user is standing, the location of the user in relation to the advertiser, if the user located in an advertiser's store or nearer one advertising store than another advertising store, whether the user is in (or traveling to) a competitors store, and so forth.

According to some aspects, the factors can be a function of the manner in which the users (or entity) entered the markers. Such factors include the zoom level used to enter the marker. Other factors relate to the view direction used to enter the marker, which can limit the visibility of the markers to new users. For example, a user might be closer to one marker, but that marker is related to the view behind him and he will not see the marker from his current view direction.

Additionally or alternatively, context can relate to the content of the marker, which can be considered an external factor. The context of the marker can be ascertained through analysis of parameters associated with the marker. Such parameters can be determined based on data included in the marker, such as key words, key phrases, character strings, or other criteria that can be extracted from the marker (e.g., a creation date, an expiration date, and so forth). According to some aspects, the parameters can relate to the source of the marker (e.g., friend, boss, co-worker, stranger, business, government agency, and so forth). Other parameters can relate to the subject of marker (e.g., “cooking”, “sports”, “politics”, “music”, electronics”, and so forth). Additionally or alternatively, parameters can relate to inappropriate content and/or undesired content, which can be determined based on user input (e.g., “never present me with content related to xyz”) and/or inferred by system 100 (e.g., the user immediately deletes or closes a marker associated with xyz). Further, another context can be the reliability of the marker such as if a user entered the data or if it is official data (e.g., related to a government agency, a business, and so forth). The reliability of the marker can also include the score of the user that entered the data, which can be based on ratings of other markers entered by the same user and an average of the reliability of this user's markers.

Also included in system 100 is an evaluation component 104 that is configured to evaluate one or more of the contexts as a function of usage parameters. The usage parameters can relate to a current time, a scheduled appointment, a user location, orientation of the user, a user preference, or combinations thereof. For example, system 100 can access the user's calendar and determine that the user has an appointment in half an hour. Further, system 100 can determine the location of the appointment in relation to the current location of the user (e.g., the distance between the current location and the appointment location).

A selection component 106 is configured to determine (or infer) a receptiveness that the user might have for a marker based on the evaluated context and/or usage parameters and selects the marker(s) from a multitude of markers (which can be alternative markers). A marker is selected if user receptiveness to the marker is above a threshold level, as determined by evaluation of user surroundings, environment, a time, a location, a scheduled appointment, orientation of the user, or combinations thereof. For example, continuing the above example, if the appointment location is twenty minutes away and the user is standing in front of a coffee shop, selection component 106 can determine whether it is appropriate to render the marker (such as an advertisement) to the user.

In accordance with some aspects, selection component 106 might determine that providing a marker for consumption by the user is inappropriate (e.g., the user is running late for a meeting and does not have time to consume the information). In accordance with some aspects, selection component 106 can evaluate external information (e.g., is the coffee shop busy, how many people are ahead of this user in line waiting for service, and so forth), internal factors (e.g., is the user in a bad mood and, therefore, not receptive to interruptions), user preferences, preferences of the user's friends and/or similar profiled users, and so on in order to make the determination whether one or more markers should be presented.

In an example, if the user has an hour to arrive at the destination, it might be appropriate to present the marker to the user. Such determination can be made by evaluating routes that can be taken to the intended destination and comparing the travel time with a difference between the appointment time and the current time (e.g., available time). If the travel time of all possible routes is about the same as the available time (or is more than a configurable percentage of the available time, such as 75% or more, 65% or more, 80% or more, and so on), it might not be appropriate to render the marker. However, if the travel time is shorter than the available time by a configurable percentage, it might be determined that it is appropriate to render the marker.

An output component 108 is configured to selectively render the marker to the user in a perceivable format (e.g., audio, visual, tactile, and so forth). The rendered marker is presented as a function of the one or more contexts and the inferred receptiveness. If the inference by selection component 106 indicates that the user has a low receptiveness to the marker (e.g., the user might not want to perceive the marker), the marker is not rendered by output component 108.

In accordance with some aspects, considerations related to a current activity can be taken into account by output component 108 to determine whether it is appropriate to render the marker. For example, if the user is operating a vehicle, output component 108 might defer presenting the marker until the vehicle is stopped, such as at a red light. In accordance with some aspects, output component 108 can render the marker in an audible format (instead of a visual format) if the user is operating a vehicle. Such determinations can be made by evaluating the user environment and utilizing the environment information to selectively alter the rending of markers in order to enhance a user experience.

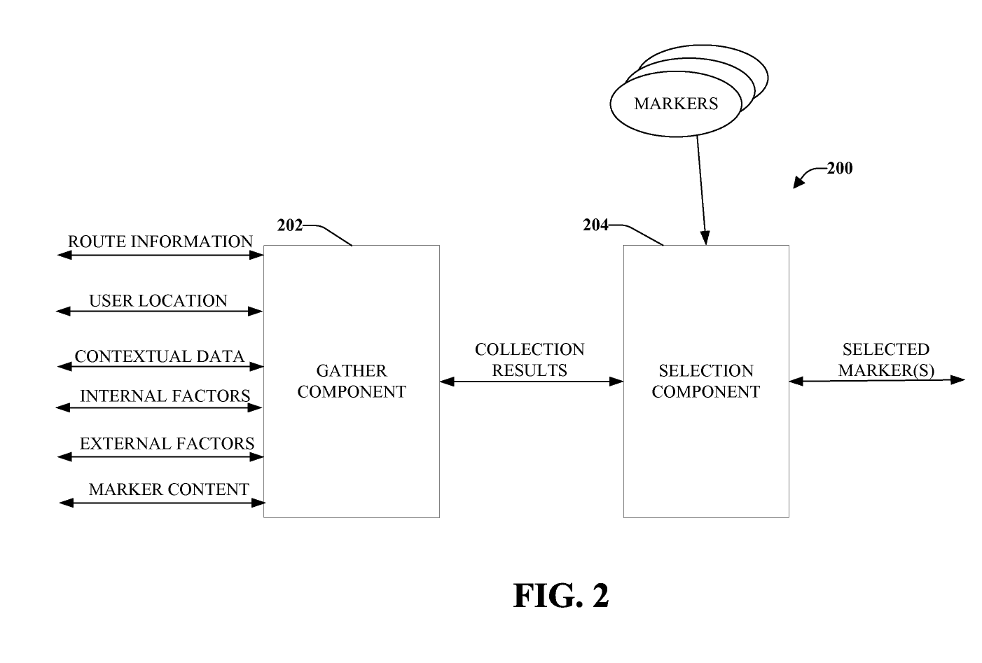

FIG. 2 illustrates an example system 200 for providing markers relevant to an intended destination and/or based on relevant factors in accordance with an aspect. At times, a user follows specific actions of a computer-generated route, such as turn left at ‘Market Street’, to arrive at an intended destination. In order to have an improved travel experience, information related to the intended destination can be provided to the user (e.g., vehicle operator, vehicle passenger, person walking or using other means of transportation, and so forth). In accordance with some aspects, information, such as markers, can be selectively presented to the user to increase the user's awareness of surroundings as well as enhancing the user experience as it relates to interacting with entities in the environment and/or performing actions or tasks in a more efficient manner. For example, the marker can be an advertisement that is presented as a function of user receptiveness.

A gather component 202 collects input data such as route information, a user location, and contextual data, which can include, external factors, internal factors, content of the marker, and so on. In order to reach a destination, a user can have an intended route to follow through operation of a vehicle (e.g., automobile, motorcycle, bicycle, airplane, helicopter, motorboat, self-balancing transportation device, and so forth) and/or though other manners of arriving at a destination (e.g., walking, taking public transportation, and so on). Route information collection can take place according to various manners of collection. For example, a computer-generated route can be produced on a vehicle navigation system whereby gather component 202 extracts the route from the navigation system. In another example, a user can produce a route from a home computer through an Internet web site and the home computer can communicate with the gather component 202 and transfer the route. In accordance with some aspects, the route can be produced on a user device, which, at least partially, includes system 200.

In accordance with some aspects, learning can take place upon (or by) gather component 202 as a function of historical data. Further, a user can manually input an intended route and/or the route can be determined based on historical information (e.g., when traveling between some locations the user has historically taken the same route). In another example, at 8:30 a.m. on weekdays (Monday through Friday), the user generally drives from her home to her office. Gather component 102 can track this driving pattern (over a period of days, weeks, months, and so forth) and infer (e.g., through artificial intelligence techniques or other machine learning and reasoning techniques) that on a particular day the route will be from her home to her office at a requisite time.

In accordance with some aspects, operational patterns of more than one individual can be considered by gather component 202 to learn information and modify operation of system 200. For example, a central server can track implementations of the system 200 in multiple vehicles, portable electronic units, and so on. In an illustrative example, a company can operate a chain of stores that sell business suits for men. Central server can track that men with a characteristic (or demographic) of being retired typically do not accept (or disregard) markers that suggest detours to pass the suit store, even when a relatively high amount of money is offered for the activity (which is rendered in the form of a marker). Central server can infer (e.g., through artificial intelligence and/or other techniques) that, in general, retired men do not desire to take detours past suit stores. Gather component 202 can use the inference result to filter out requests made by the suit store to present a potential customer with a marker, in the form of an advertisement or promotional material.

In accordance with some aspects, system 200 can be utilized to balance traffic, business, and other flows of people and/or objects (e.g., vehicles). For example, during a popular event where a relatively large number of vehicles are expected to park, system 200 can instruct some people (through rendering of respective markers) to travel to a first parking area (e.g., a north parking lot) and others to travel to a subsequent parking area (e.g., a south parking lot) in order to attempt to keep traffic flowing smoothly. Similarly, if there is an accident or traffic jam, system 100 can route different users with different alternate routes to balance the traffic by presenting markers that include this information (e.g., based on traffic information gathered from various sources including news streams). A central server can communicate traffic balance information as contextual data to gather component 202 and selection component 204 can utilize the traffic balance information in order to choose a detail for disclosure as a marker (e.g., offer a recommendation to the user as to a route that should be taken, advise the user not to use a specific road, and so forth).

In accordance with some aspects, a user location can be relevant when determining which marker to disclose (e.g., provide to the user) concerning an intended destination and/or other information. For instance, if a user operating an automobile is over two hours away from the intended destination, for example, traffic accident information near the intended destination is likely irrelevant since the accident should be cleared after an hour or so. Thus, a marker related to the traffic accident is not rendered.

A large amount and/or variety of contextual data can become important while determining which marker to render. A non-exhaustive list of contextual data includes available details that can be disclosed to a user, weather information, traffic histories, event schedules, business sales, traffic pattern estimations, and so forth. Other contextual data can relate to both internal parameters and external parameters, including parameters associated with content of a marker (e.g., the subject of the marker, the identification of the entity that provided the marker, the date the marker was created, and so forth).

Gather component 202 transfers collection results to a selection component 204. The transfer can be a continuous stream (e.g., as information is collected, it is transferred to selection component at about the same time as received), it is transferred as a single block (e.g., information is retained in storage and transferred to selection component 204 as a single event), or it can be placed in storage and selection component 204 reads collection results off the storage, and so forth. Selection component 204 can choose a marker associated with an intended location (e.g., intended destination, intended route waypoint, intended placement on a path, and so forth.) to present to a user. The marker choice can be based upon route information, user location, contextual data, internal factors, external factors, content of the marker, user preferences, or a combination thereof. It is to be appreciated that an intended destination does not have to be a final destination. For example, the intended destination can be an intermediate destination (e.g., a person leaving an office can have a final destination of home, but a first intended destination of stopping at a gas station). Through detailed analysis, selection component 204 can determine a detail, such as a marker, that would be beneficial to disclose to a user and which would be relevant to the user given the user's current context.

According to some aspects, the chosen detail (or marker) is a commercial marker, such as a product advertisement, a coupon, information concerning a sale, and so on. For example, if the intended destination is a grocery store, selection component 204 can choose to inform the user (through presentation of a marker) about a sale on milk. In a different instance, if the intended destination is a rental store, the user can be informed that a bank is located nearby with a goal that the user will stop by the bank to make a financial transaction (referred to as a marker created and associated with a commercial entity).

In another example, a user can be driving a vehicle on a road upon a generated route. System 200 can determine it is twelve noon and a user has not eaten lunch and/or does not have a plan on where to eat lunch (e.g., learned through examination of a user schedule, monitoring of automobile conversation, and so on). A commercial detail, in the form of a marker, can be submitted to the user to entice the user to have lunch at a particular restaurant near the road. The decision to show information can also be effected by personal history and not just the absolute time. For example, the fact that the user has been driving for two hours and may need rest and refreshment can be taken into consideration. In another example, the fact that the user has been driving for two hours might be utilized to factor in that it is expected that the vehicle will need refueling after a given distance.

Moreover, selection component 204 can choose the marker (or detail) based upon a financial consideration. For example, a number of businesses near an intended destination can have a desire to have their information presented to a user. In this type of situation, an auction can take place through interaction by the interested commercial entities with selection component 204 or another device, such as a remote database. In the “auction”, different businesses entities can offer to pay a fee to have a commercial marker presented. In accordance with some aspects, a flat rate can be paid for a set amount of presentations (e.g., about 1000 presentations) and selection component 204 can determine an appropriate instance in which to disclose a paid commercial marker. Determination by selection component 204 related to if an instance is appropriate can be based upon demographics of a user/vehicle occupants, detail supplier conditions (e.g., disclose a detail stating a store sells umbrellas when there is rainfall), manually pushed by a supplier (e.g., if a store is not busy, then a retailer can communicate to system 100 and request that system 100 disclose a marker related to a discount offer), based on context, and so on.

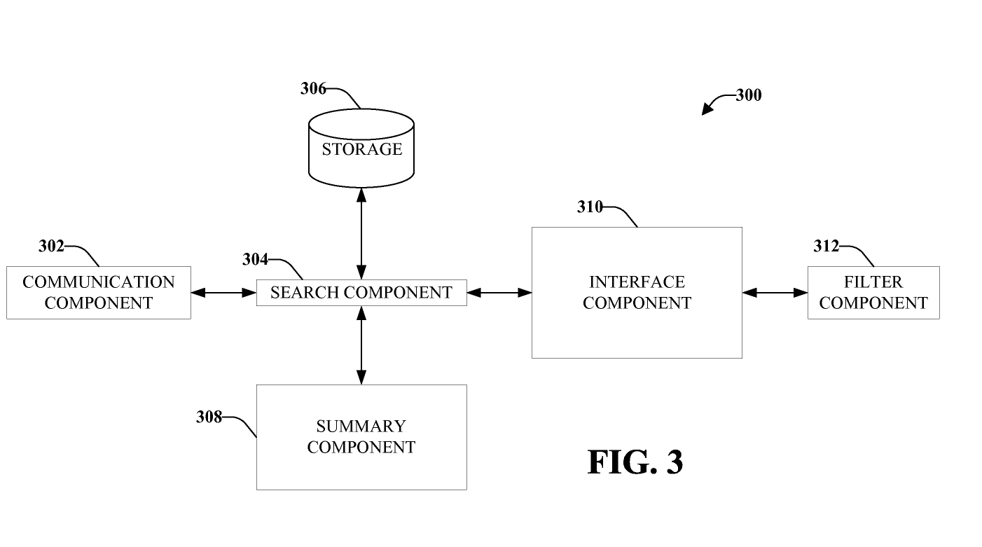

FIG. 3 illustrates a schematic representation of details related to gathering context information according to various aspects disclosed herein. A communication component 302 can be configured to engage with other devices to transfer information. The other devices can be other computing devices utilized by a first user, mobile devices utilized by other users and/or computing devices associated with various entities. System 300 operation can take place wirelessly, in a hard-wired manner, employment of security technology (e.g., encryption), and so on. Moreover, communication component 302 can utilize various protective features, such as performing a virus scan on obtained data (e.g., markers) and blocking those markers that are positive for a virus. In accordance with some aspects, communication component 302 can block markers that contain inappropriate content and/or undesired content (as determined by user preferences).

A search component 304 can be configured to locate information related to a user including user preferences related to markers, a current user location, an intended user location, contextual data and extract at least some details from the located sources. The sources of information can be accessed through utilization of communication component 302. Search component 304 can search storage 306 (e.g., local storage, remote storage, and so forth) in order to locate related information (e.g., a route a user is predicted to take to an intended destination). According to some aspects, a global positioning system can supply user location information obtained by search component 304. Moreover, a data network (e.g., the Internet), can be contacted in order to determine contextual data (e.g., available markers to present to the user).

Search component 304 can also gain contextual information from a personal profile (e.g., user preferences) retained in storage 306. The personal profile can be created through interaction with a summary component 308. Summary component 308 can construct a profile of at least one user and/or entity. As used herein, “construction” includes both building the profile as well as updating the profile, which can be performed thorough adaptive learning. A user and/or another person (e.g., passenger in the vehicle) can be located in a vehicle that includes system 300. However, the disclosed aspects are not limited to people and an entity can be a family pet. According to an aspect, when a person enters a vehicle, they ‘log-on’ to an on-board computer (e.g., a driver and passengers). If a profile has not been created, then summary component 308 builds the profile. If there is an existing profile, summary component 308 updates the profile, if current and/or expanded data is available. The profile can include information such as physical characteristics, personal interests, and so forth.

The personal profile can be retained in storage 306, which can be storage that is accessible by search component 304. Storage 306 can be arranged in a number of different configurations, including random access memory, battery-backed memory, hard disk, magnetic tape, and so forth. Further, various features can be implemented upon storage, such as compression and automatic back up (e.g., use of a Redundant Array of Independent Drives configuration). In accordance with some aspect, the information can be retrieved from a user device.

An interface component 310 allows an entity to enter specific information that can be used by a selection component. For example, a vehicle operator can desire to travel to a university in a rural area. In this example, the operator does not know the address; however, the university is in a small town and once in the small town, the university is easy to find (e.g., the operator will follow roadside signs). A route might indicate for the operator to travel to the city center. However, the operator can provide contextual information (through the interface 310) that she is actually looking to travel to the University. Example interface components 310 can include a touch screen (e.g., a screen that can also present information), a microphone, a keyboard, and so forth. A user can input information thorough interaction with interface component 310, such as requesting markers that provide alert information. For instance, the user can request that a marker should be rendered when an outlet mall is within a given radius of an intended location (e.g., a point along a route).

Information from search component 304, storage 306, interface component 310, an auxiliary location, and so on can be processed by a filter component 312, which can limit information that can pass to selection component. Search component 304 and interface component 310 can gather a relatively large amount of information. In accordance with some aspects, the amount of information that is selected can overburden selection component, which might not operate efficiently (e.g., a large amount of processing is needed, which slows operation). Filter component 312 can pass some markers to selection component while stopping (or blocking) other markers. Internal logic (e.g., complex algorithms) can be utilized to determine what markers would be beneficial to selection component and what would be extraneous. Moreover, internal logic can be modified, such as by a technician or it can be modified adaptively, to correct errors (e.g., information is passing that should not, information is being blocked that should not, and so on.), thus improving performance.

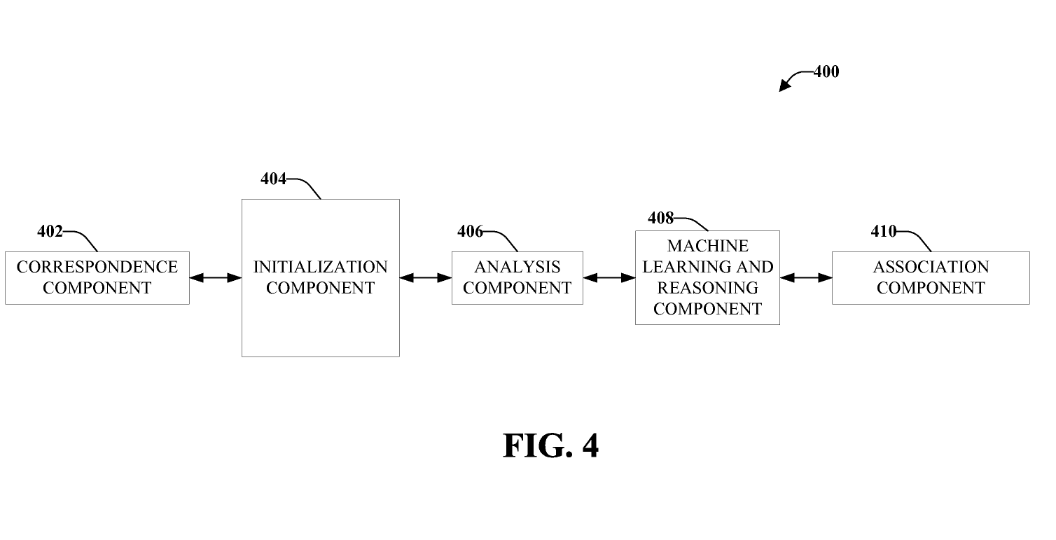

FIG. 4 illustrates a schematic representation of details related to selectively choosing one or more markers, according to an aspect. A correspondence component 402 can engage with other devices and/or entities to transfer information, such as a marker. Operation can take place wirelessly, in a hard-wired manner, through employment of security technology (e.g., encryption), and so forth. Moreover, correspondence component 402 can utilize various protective features, such as performing a virus scan on obtained data and blocking information that is positive for a virus, for example.

An initialization component 404 can be configured to allow an individual to receive additional destination content and/or markers automatically. While a user can request additional content through an interface component, the user can also be provided content automatically. For example, as a user becomes geographically close to an intended destination, initialization component 404 can transmit a signal that indicates commercial detail information (e.g., markers related to an entity) should be automatically disclosed to the user.

An analysis component 406 can be configured to evaluate collection results. Various calculations can be performed by analysis component 406 to perform the analysis. For example, interests stored in a personal profile can be compared against available businesses near an intended destination and/or at a current user location. If a user has a history of struggling to find a parking space in a crowed location, then analysis component 406 can perform an evaluation to determine parking lots near the intended destination. Analysis component 406 can be configured to analyze an intended travel destination of a user as well evaluate information and/or provide markers. Further, commissioning information associated with the intended travel destination for presentment to the user utilizes the evaluated information to commission information.

A machine learning and reasoning component 408 can ascertain at least one inference or at least one determination in relation to detail choice. Various scenarios can occur that are processed by machine learning and reasoning component 408. For example, machine learning and reasoning component 408 can receive evaluations of analysis component 406 and determine details related to an intended destination that should be presented to a user. In an example, a fast food restaurant chain can pay for ten presentations (for example) for people associated with a vehicle where the people have an intended destination near a restaurant (which might be a competitor's restaurant). In another example, a fast food restaurant is about two miles from the intended destination, but is the closest eating establishment. In this situation, machine learning and reasoning component 408 can infer that the two-mile away restaurant is a quality instance for which to present a commercial detail (e.g., marker) and send a notification that the commercial detail should be rendered.

Machine learning component 408 can employ various machine learning techniques to automate one or more features. For example, machine learning and reasoning component 408 can employ principles of probabilistic and decision theoretic inference and rely on predictive models constructed through the use of machine learning procedures. Logic-centric inference can also be employed separately or in conjunction with probabilistic methods. Machine learning and reasoning component 408 can infer external context parameters by obtaining knowledge about the possible actions of the user and knowledge about what is occurring in a local environment. Based on this knowledge, the machine learning and reasoning component 408 can make an inference related to whether a marker is appropriate in a particular situation.

The disclosed aspects can employ various artificial intelligence-based schemes for carrying out various aspects thereof. For example, a process for determining if a particular marker is to be presented can be enabled through an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action (e.g., rendering of a marker) that a user desires to be automatically performed.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more aspects can employ classifiers that are explicitly trained (e.g., through a generic training data) as well as implicitly trained (e.g., by observing user behavior, receiving extrinsic information, and so on). For example, SVM's are configured through a learning or training phase within a classifier constructor and feature selection module. Thus, the classifier(s) can be used to automatically learn and perform a number of functions, including but not limited to determining according to a predetermined criteria when to render a marker, which marker to render, which (if any) markers to render at substantially the same time, relationships between markers (e.g., alternative markers, markers related to a similar entity), and so forth. The criteria can include, but is not limited to, similar markers, receptiveness of the user, and so forth.

Additionally or alternatively, an implementation scheme (e.g., rule) can be applied to control and/or regulate rendering of markers, modification to a marker, and so forth. It will be appreciated that the rules-based implementation can automatically and/or dynamically evaluate a marker based upon a predefined criterion. In response thereto, the rule-based implementation can automatically interpret and carry out functions associated with presentation of markers by employing a predefined and/or programmed rule(s) based upon any desired criteria.

An association component 410 can be configured to integrate a detail with an intended destination and/or a current location. For example, a determination can be made by machine learning and reasoning component 408 that a traffic report should be provided to an operator. However, the operator is about two hours away from the intended destination. Association component 410 can monitor operations and link the report with the intended destination and, when the vehicle is closer to the intended destination, an updated traffic report can be disclosed.

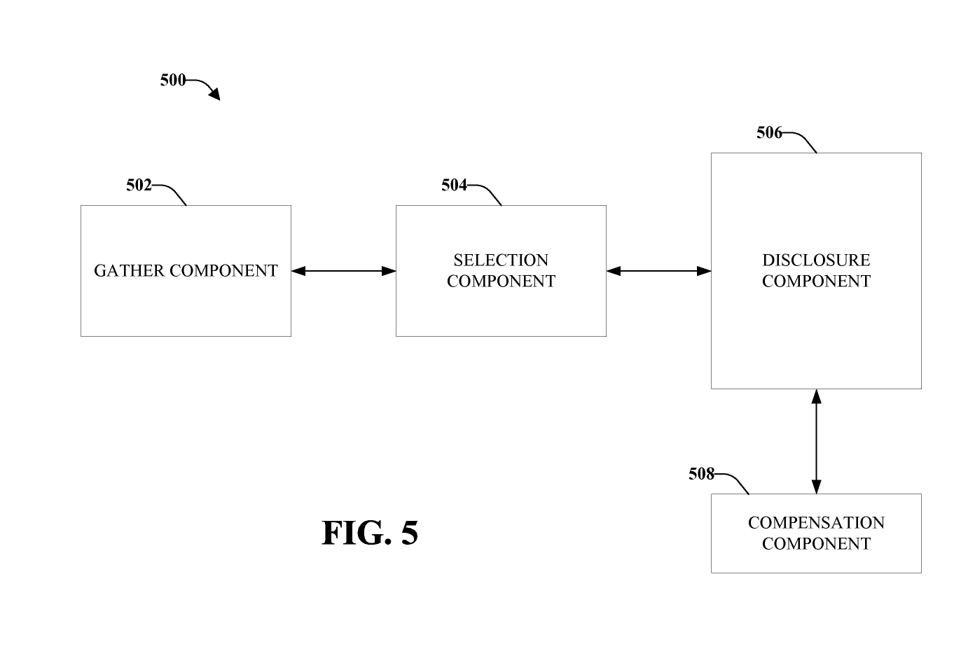

With reference now to FIG. 5, illustrated is a system 500 for disclosing a marker associated with an intended destination and/or marker and performing a calculation, according to one or more of the disclosed aspects. A gather component 502 collects route information, a user location, and contextual data and transfers this collection to a selection component 504. Selection component 504 can select a marker associated with an intended location output to a user. The detail choice can be based upon route information, the user location, contextual data, external factors, internal factors, content of the marker, or a combination thereof.

A disclosure component 506 outputs the chosen marker(s) to the user(s). Disclosure component 506 can allow an individual to perceive the marker at a time when the user might be more receptive and, therefore, might act upon the marker. A non-exhaustive list of disclosure components include a display screen, touch screen, speaker system, virtual reality environment, Braille production system, printer, and so forth. In addition, disclosure component 506 can present information in multiple formats, such as showing a video with audio capabilities.

According to an aspect, gather component 502 can receive information that a red light at a particular intersection is about to be approached and that the red light lasts for about twelve seconds (such information can be gathered from a government agency, such as a traffic control center). Selection component 504 can select a marker, such as a commercial detail video that lasts for about twelve seconds. This allows a user to perceive the marker without being distracted during moving vehicle operations (e.g., the marker is only presented while the vehicle is not in motion).

Furthermore, disclosure component 506 can include adaptive logic for rendering markers. Associated with system 500 can be a video monitor. For example, the video monitor (as well as audio speakers) can be located in a center console next to a steering wheel. In one example, while the automobile is at the stop light, a video plays with sound. However, when the automobile is in motion the video stops and only sound is played, thus causing less distraction to an operator.

Additionally or alternatively, system 500 can be equipped with a compensation component 508, which can be configured to provide a reward in relation to consumption of the marker by the user. Operation of compensation component 508 can enable a fiscal transaction to take place; however, non-fiscal implementations can be practiced (e.g., a driver is awarded video game points that can be exchanged for prizes for listening to a commercial marker).

Different configurations can allow transactions to take place. For example, a user can be paid money from an advertiser for being subjected to the commercial marker. Alternatively or additionally, a user can pay money to a provider of system 500 in order for the user to be presented with valuable traffic information. For example if an intended destination has heavy traffic, a marker, such as a message or voice call, is transmitted to the user's personal digital assistant that she should leave earlier than expected).

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

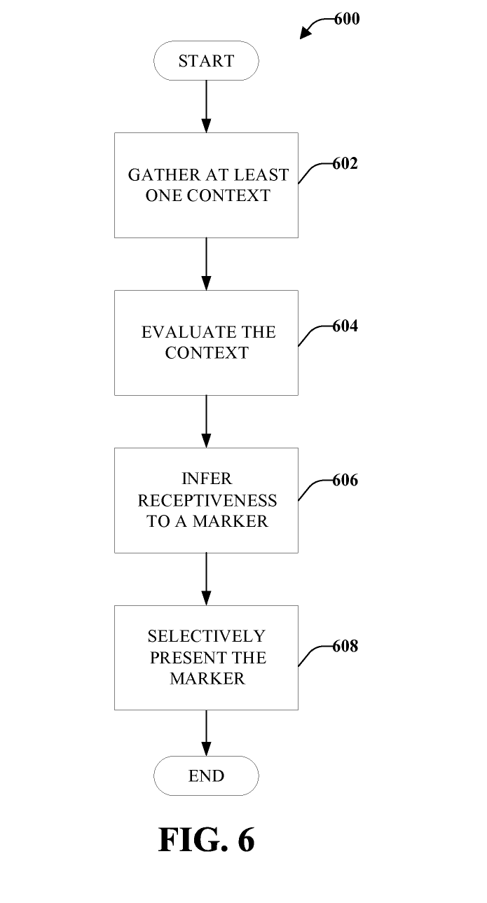

FIG. 6 illustrates a method 600 for selectively rendering markers, according to an aspect. Method 600 can be configured to determine when to render markers and when not to render markers as a function of various contexts associated with a user, such as, internal parameters, external parameters, as well as other criteria (e.g., content of the marker). For example, a marker might not be rendered if it is determined that the user does not have a required amount of time to benefit from the marker (e.g., no time to visit the store that is advertising through the marker).

Method 600 starts, at 602, what at least one context is gathered. The gathered contexts can relate to a user and can include parameters such as the mood of the user, the orientation of the user, or other criteria that can be utilized to indicate the user's receptiveness. Alternatively or additionally, gathered contexts can relate to external parameters, such as a current wait time at a local restaurant, reviews of the restaurant left by friends, and so forth. Contexts can also relate to the content of the marker, such as the topic of the marker, reliability of the source of the marker, correlation of that source to other markers with past user interests (e.g., has the user been interested in this persons markers or is the user not interested at all), and so on.

At 604, the one or more gathered contexts are evaluated as a function of a current time, a scheduled appointment, a user location, orientation of the user, or combinations thereof. Based on the gathered contexts, a user receptiveness to the marker is inferred. For example, there are three different contexts gathered and evaluation of the contexts reveals that a first gathered context indicates that the user is interested in a new coffee machine, a second gathered context indicates that the content of a marker is for a discounted price on a coffee machine, and a third gathered context indicates that there are people standing in line at a counter to purchase coffee and the estimated wait time is ten minutes. If a fourth gathered context indicates that the user has only five minutes to spare before having to leave for an intended destination (e.g., scheduled meeting), the marker might still be rendered to the user since the user can look at the coffee machine without waiting in line. In this situation, the user can look at the coffee machine and determine if it is a machine that the user would like to purchase. Although the user might not have time to make the purchase immediately, the user can save time by reviewing this coffee machine now and making the purchasing decision later. This would also save time especially if the user is not interested in this particular coffee machine (e.g., the user can disregard (or the system can automatically not render) future markers related to this style of coffee machine).

At 608, the marker is selectively presented to the user as a function of one or more contexts and the inferred receptiveness. If the inference indicates that the user has a low receptiveness to the marker based on one or more contexts (both internal and external), the marker is not rendered. If a context indicates that the orientation of the user is focused on a certain parameter, one of a combination of alternative markers can be selectively presented. For example, if competing stores are advertising for business and the user is located near a first store, the user might be presented with markers associated with that first store. However, if a user is located near two stores and both stores would like to have an advertising marker presented, different criteria can be utilized (e.g., focus of the user, historical data related to the store the user generally visits, user preferences, and so forth). In accordance with some aspects, the user can be presented with markers associated with both stores in order for the user to make her own decision.

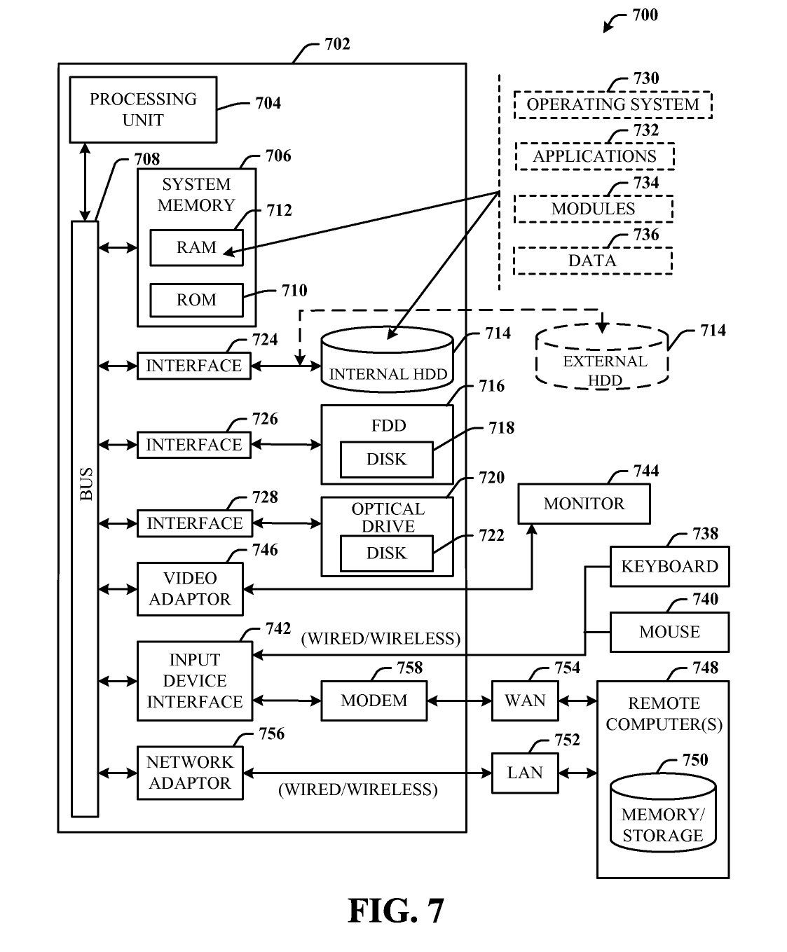

Referring now to FIG. 7 illustrated is a block diagram of a computer operable to execute the disclosed architecture. In order to provide additional context for various aspects disclosed herein, FIG. 7 and the following discussion are intended to provide a brief, general description of a suitable computing environment 700 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the various aspects can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 through an interface, such as a video adapter 746. In addition to the monitor 744, a computer typically includes other peripheral output devices (not shown), such as speakers, printers, etc.

The computer 702 may operate in a networked environment using logical connections through wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 through the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

In accordance with some aspects, Memory 706 can be communicatively coupled to processing unit 704 and can retain information related to a implementing a system that facilitates rendering one or more markers according to the disclosed aspects. System can include a gather component that compiles one or more contexts and an evaluation component that evaluates the contexts as a function of usage parameters. The one or more contexts are non-personal external factors, personal external factors, internal factors, marker content, or combinations thereof. The usage parameters include a current time, a scheduled appointment, a user location, orientation of the user, or combinations thereof. Further, system can include a selection component that determines a user receptiveness based on at least the context and the evaluated usage parameters and chooses at least one marker from a plurality of markers. In accordance with some aspects, the selection component reviews user preferences to select the at least one marker. The plurality of markers include at least two alternative markers, the selection component chooses one of the alternative markers based on a user orientation. System can also include an output component that renders the selected marker. The output component does not render the marker if the user is not receptive to the marker. The markers can be personalized for the user and/or, a generic marker intended for a multitude of users.

According to some aspects, processing unit 804 can be employed to execute computer executable instructions stored on a computer readable storage medium. Processing unit 804 can execute gathering at least one context associated with a user and evaluating the at least one context as a function of a current time, a scheduled appointment, a user location, orientation of the user, or combinations thereof. At least one context can be an external factor based on an environment, a personal factor related to the user and/or a content of the marker. Further processing unit 804 can execute inferring a receptiveness to a marker based on the evaluated context and selectively presenting the marker as a function of the at least one context and the inferred receptiveness. The marker is not presented if the inference indicates a low receptiveness to the marker (e.g., user would not be interested in the marker). According to some aspects, the marker can be an advertisement, a personalized marker, and/or a generic marker. Alternatively or additionally, processing unit 804 can determine a marker to present as a function of an orientation of the user.

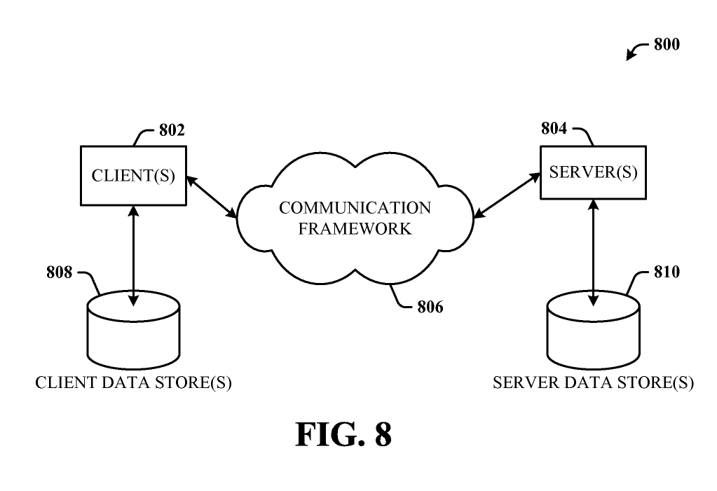

FIG. 8 illustrates a schematic block diagram of an exemplary computing environment 800 in accordance with the various aspects. The system 800 includes one or more client(s) 802. The client(s) 802 can be hardware and/or software (e.g., threads, processes, computing devices). The client(s) 802 can house cookie(s) and/or associated contextual information by employing the various aspects, for example.

The system 800 also includes one or more server(s) 804. The server(s) 804 can also be hardware and/or software (e.g., threads, processes, computing devices). The servers 804 can house threads to perform transformations by employing the various aspects, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated through a wired (including optical fiber) and/or wireless technology (including non-radio wireless communications). The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.”

The term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that facilitates rendering markers, comprising:
a gather component that compiles one or more contexts;
an evaluation component that evaluates the contexts as a function of usage parameters;
a selection component that determines a user receptiveness based on at least the context and the evaluated usage parameters and chooses at least one marker from a plurality of markers; and
an output component that selectively renders the selected marker.

2. The system of claim 1, the one or more contexts are non-personal external factors, personal external factors, internal factors, marker content, or combinations thereof.

3. The system of claim 1, the usage parameters include a current time, a scheduled appointment, a user location, orientation of the user, or combinations thereof.

4. The system of claim 1, the marker is an advertisement.

5. The system of claim 1, the plurality of markers include at least two alternative markers, the selection component chooses one of the alternative markers based on a user orientation.

6. The system of claim 1, the output component does not render the marker if the user is not receptive to the marker.

7. The system of claim 1, the marker is personalized for the user.

8. The system of claim 1, the marker is a generic marker intended for a multitude of users.

9. The system of claim 1, the selection component reviews user preferences to select the at least one marker.

10. A method for rendering a marker, comprising:
gathering at least one context associated with a user;
evaluating the at least one context as a function of a current time, a scheduled appointment, a user location, orientation of the user, or combinations thereof;
inferring a receptiveness to a marker based on the evaluated context; and
selectively presenting the marker as a function of the at least one context and the inferred receptiveness.

11. The method of claim 10, the marker is not presented if the inference indicates a low receptiveness to the marker.

12. The method of claim 10, further comprises determining a marker to present as a function of an orientation of the user.

13. The method of claim 10, the marker is an advertisement.

14. The method of claim 10, the marker is a personalized marker.

15. The method of claim 10, the marker is a generic marker.

16. The method of claim 10, at least one context is an external factor based on an environment.

17. The method of claim 10, at least one context is a personal factor related to the user.

18. The method of claim 10, the at least one context is a content of the marker.

19. A computer executable system, comprising:
means for obtaining information related to a user, the information includes internal factors, personal external factors, non-personal external factors, marker content, or combinations thereof associated with a user;
means for evaluating the obtained information as a function of a current time, a scheduled appointment, a location, orientation of the user, or combinations thereof,
means for evaluating a user receptiveness to one or more of a plurality of markers and selecting at least one of the plurality of markers for which a user receptiveness level is above a threshold level; and
means for selectively presenting the at least one selected marker.

20. The computer executable system of claim 19, the means for evaluating selects from at least two markers for which a user has a receptiveness above the threshold level as a function of the user orientation.
